(19) United States
(12) Patent Application Publication
(10) Pub. No.: US 2015/0377310 A1
(43) Pub. Date: Dec. 31, 2015

(54) Brake Assembly Bonded with an Adhesive

(71) Applicant: ArvinMeritor Technology, LLC, Troy, MI (US)

(72) Inventor: Lebree Jones, Troy, MI (US)

(21) Appl. No.: 14/319,725

(22) Filed: Jun. 30, 2014

(51) Int. Cl. F16D 65/22; F16D 51/22

(52) U.S. Cl. CPC F16D 65/22; F16D 51/22; F16D 2121/14

(57) ABSTRACT

A brake assembly having a bracket assembly that may receive a camshaft that actuates a brake pad assembly. The bracket assembly may include a camshaft tube, a mounting flange, and a brake wing. The mounting flange and/or the brake wing may be attached to the camshaft tube with an adhesive.

### TECHNICAL FIELD

This patent application relates to a brake assembly having a bracket assembly that may be bonded with an adhesive.

### BACKGROUND

A bracket for a vehicle brake assembly is disclosed in U.S. Pat. No. 5,649,612.

### SUMMARY

In at least one embodiment, a brake assembly is provided. The brake assembly may receive a camshaft for actuating a brake pad assembly. The bracket assembly may include a camshaft tube and a mounting flange. The camshaft tube may extend along an axis and may have a first tube end and a second tube end disposed opposite the first tube end. The mounting flange may be disposed proximate the first tube end. The mounting flange may be attached to the camshaft tube with an adhesive that may be disposed between the mounting flange and the camshaft tube. The mounting flange and the camshaft tube may cooperate to define a hole that receives the camshaft.

In at least one embodiment, a brake assembly is provided. The brake assembly may receive a camshaft for actuating a brake pad assembly. The bracket assembly may include a camshaft tube and a brake wing. The camshaft tube may extend along an axis and may have a first tube end and a second tube end disposed opposite the first tube end. The brake wing may be disposed proximate the second tube end. The brake wing may be attached to the camshaft tube with an adhesive that may be disposed between the brake wing and the camshaft tube. The brake wing and the camshaft tube may cooperate to define a hole that receives the camshaft.

### BRIEF DESCRIPTION OF THE DRAWINGS

FIG. 1 is a perspective view of an exemplary brake assembly having a bracket assembly.

FIG. 2 is a perspective view of the bracket assembly of FIG. 1.

FIG. 3 is an exploded view of the bracket assembly of FIG. 1.

FIG. 4 is a section view of the bracket assembly along section line 4-4.

FIG. 5-7 are section views of additional bracket assembly configurations.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

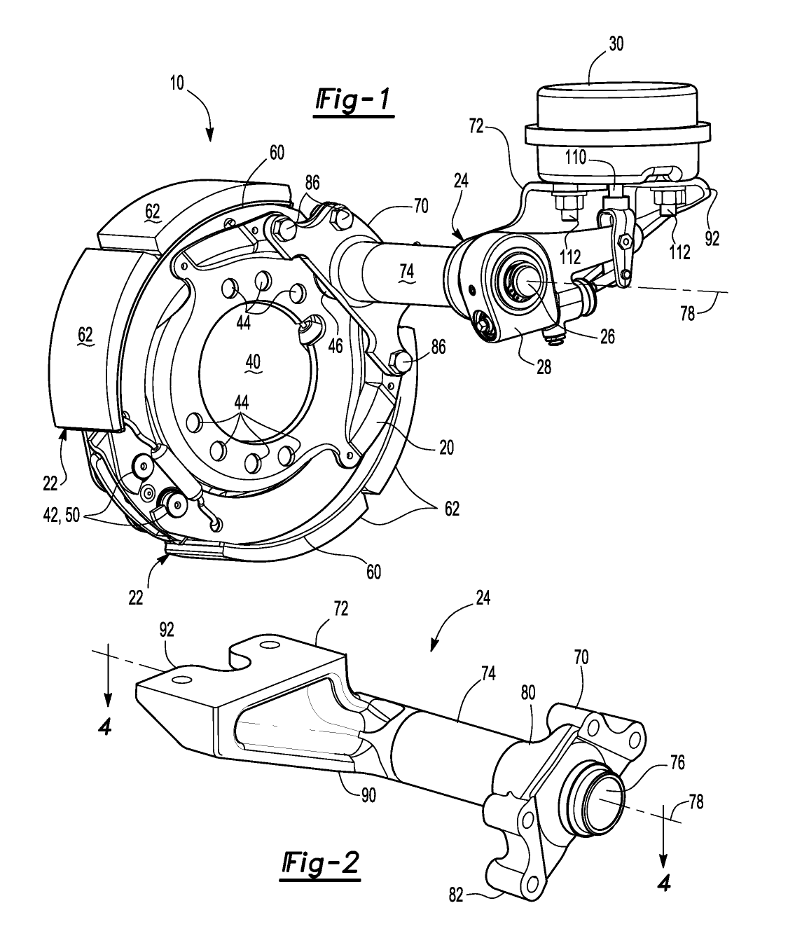

Referring to FIG. 1, an exemplary brake assembly 10 is shown. The brake assembly 10 may be provided with a vehicle, such as a motor vehicle like a truck, bus, farm equipment, mining equipment, military transport or weaponry vehicle, or cargo loading equipment for land, air, or marine vessels. In addition, the brake assembly 10 may be provided on a trailer that may be coupled to or provided with a motor vehicle.

The brake assembly 10 may be a friction brake that may be configured to slow or inhibit rotation of at least one associated wheel. In FIG. 1, the brake assembly 10 is depicted as a drum brake. In a drum brake configuration, a brake drum may extend continuously around brake pad assembly that may be configured to engage the brake drum to slow the rotation of a wheel. The brake drum may be disposed between a wheel and a wheel hub assembly that may rotatably support the wheel. In at least one embodiment, the brake assembly 10 may include a spider 20, at least one brake pad assembly 22, a bracket assembly 24, a camshaft 26, a slack adjuster 28, and an actuator 30.

The spider 20 may support various components of the brake assembly 10. In addition, the spider 20 may facilitate mounting of the brake assembly 10 to the vehicle. For example, the spider 20 may be fixedly disposed on or fixedly positioned with respect to an axle assembly or a steering knuckle. In at least one embodiment, the spider 20 may include a hole 40 through which an axle and/or a spindle may extend. For example, a spindle may extend through the hole 40 and may support one or more wheel bearings that may support and facilitate rotation of a wheel assembly. The spider 20 may also include at least one anchor pin hole 42, at least one spider mounting hole 44, and a camshaft opening 46.

The anchor pin hole 42 may receive an anchor pin 50 that facilitates mounting and operation of a brake pad assembly 22 will be discussed in more detail below. In the embodiment shown, two anchor pin holes 42 are provided that are generally disposed opposite the bracket assembly 24. Each anchor pin hole 42 may receive a different anchor pin 50 and each anchor pin 50 may support a different brake pad assembly 22.

A spider mounting hole 44 may facilitate mounting of the spider 20 to the vehicle. In FIG. 1, a plurality of spider mounting holes 44 are arranged around the hole 40. Each spider mounting hole 44 may receive a fastener, such as a bolt, that may extend through the spider mounting hole 44 and couple the spider 20 to another component, such as an axle assembly or a steering knuckle.

The camshaft opening 46 may receive the camshaft 26 and optionally a portion of the bracket assembly 24. The camshaft 26 may extend through the camshaft opening 46 to engage one or more brake pad assemblies 22.

One or more brake pad assemblies 22 may be disposed proximate the spider 20. In FIG. 1, two brake pad assemblies 22 are shown that may be generally disposed opposite each other. The brake pad assembly 22 may include a brake shoe 60 and a friction material 62.

The brake shoe 60 may be a structural member of a brake pad assembly 22. The brake shoe 60 may be pivotally mounted to the spider 20 at a first end via the anchor pin 50. For example, the anchor pin 50 may be fixedly positioned with respect to the spider 20 and the brake shoe 60 may pivot about an outer surface or circumference of the anchor pin 50 when the brake pad assembly 22 is actuated. An opposite end of the brake shoe 60 may have a cam roller that may be configured to engage a cam of the camshaft 26.

The friction material 62, which may also be called a brake lining, may be disposed on an outer surface of the brake shoe 60 and may face toward the brake drum. The friction material 62 may engage the brake drum during vehicle braking and may be spaced apart from the brake drum when the friction braking is not being applied.

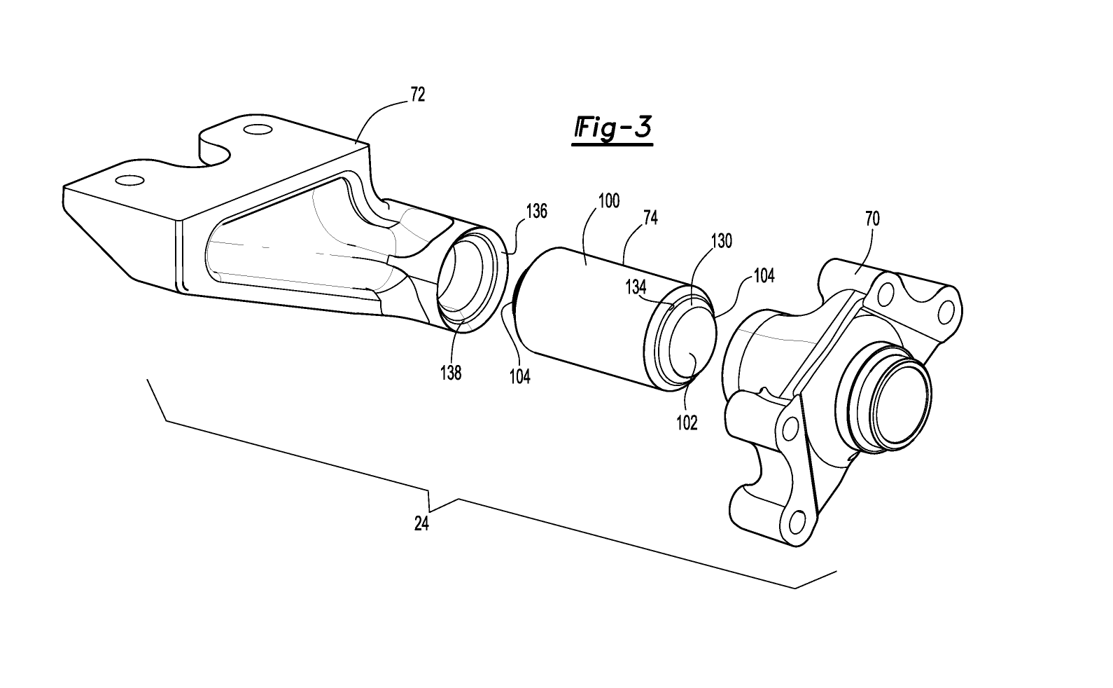

Referring to FIGS. 1 and 2, the bracket assembly 24 may facilitate mounting of the camshaft 26, the slack adjuster 28, and the actuator 30. The bracket assembly 24 may include a mounting flange 70, a brake wing 72, and a camshaft tube 74. In addition, the bracket assembly 24 may have a hole 76 that may receive the camshaft 26. The hole 76 may be a through hole that may extend through the bracket assembly 24. The hole 76 may extend along an axis 78 and may be defined by hole portions in the mounting flange 70, the brake wing 72, and the camshaft tube 74 as will be discussed in more detail below.

The mounting flange 70 may facilitate mounting of the bracket assembly 24 to the spider 20. The mounting flange 70 may be spaced apart from the brake wing 72 and may be fixedly coupled to the camshaft tube 74 with an adhesive as will be discussed in more detail below. In at least one embodiment, the mounting flange 70 may have a mounting flange body 80 and a flange portion 82.

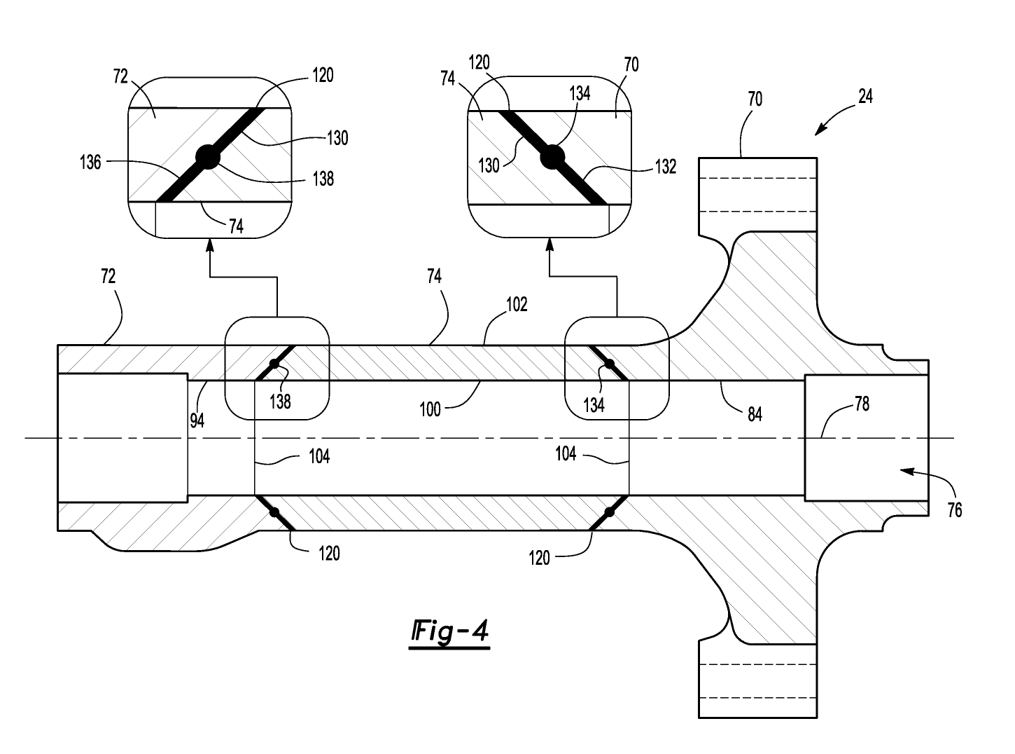

The mounting flange body 80 may have a generally tubular configuration and may define a portion of the hole 76 through which the camshaft 26 may extend. The mounting flange body 80 may have an interior surface 84, which is best shown in FIG. 4, that may be radially disposed about the axis 78 and that may at least partially define the hole 76. The interior surface 84 may be spaced apart from the camshaft 26 to facilitate rotation of the camshaft 26 and to provide a cavity for receiving lubricant. The portion of the hole 76 in the mounting flange body 80 may receive various components in addition to the camshaft 26. For example, the portion of the hole 76 may receive a bearing or bushing that may extend around the camshaft 26 to rotatably support the camshaft 26. One or more seals may also extend around the camshaft 26 to help contain a lubricant, such as grease, inside the hole 76 to lubricate the bearing or bushing.

The flange portion 82 may be configured to be mounted to the spider 20. The flange portion 82 may extend outwardly from the mounting flange body 80 and may be integrally formed with the mounting flange body 80 in one or more embodiments. For example, the mounting flange body 80 and flange portion 82 may be cast as a unitary one-piece component. The flange portion 82 may include at least one mounting hole that may be aligned with a corresponding mounting hole on the spider 20. The mounting hole may receive a fastener 86 that may couple the mounting flange 70 to the spider 20 as is best shown in FIG. 1.

The brake wing 72 may be coupled to the camshaft tube 74 and may support the actuator 30. The brake wing 72 may be spaced apart from the spider 20 and may be fixedly coupled to the camshaft tube 74 opposite the mounting flange 70. In at least one embodiment, the brake wing 72 may include a brake wing body 90 and a brake wing flange portion 92.

The brake wing body 90 may have a generally tubular configuration and may define a portion of the hole 76 through which the camshaft 26 may extend. The brake wing body 90 may have an interior surface 94, which is best shown in FIG. 4, that may be radially disposed about the axis 78 and that may at least partially define the hole 76. The interior surface 94 may be spaced apart from the camshaft 26 to facilitate rotation of the camshaft 26 and provide a cavity for receiving lubricant.

The portion of the hole 76 in the brake wing body 90 may receive various components in addition to the camshaft 26. For example, the portion of the hole 76 in the brake wing body 90 may receive a bearing, bushing, and/or one or more seals like those previously described.

The brake wing flange portion 92 may be configured to support the actuator 30. The brake wing flange portion 92 may extend outwardly from the brake wing body 90 and may be integrally formed with the brake wing body 90 in one or more embodiments. For example, the brake wing body 90 and brake wing flange portion 92 may be cast as a unitary one-piece component. The brake wing flange portion 92 may include one or more actuator mounting holes and an actuator shaft opening. Each actuator mounting hole may receive a fastener that may couple the actuator 30 to the brake wing 72.

The camshaft tube 74 may extend from the mounting flange 70 to the brake wing 72. The camshaft tube 74 may have a generally tubular configuration and may define a portion of the hole 76 through which the camshaft 26 may extend. For instance, the camshaft tube 74 may extend along the axis 78 and may have an inner surface 100 and an outer surface 102 as is best shown in FIGS. 3 and 4. The inner surface 100 may be radially disposed about the axis 78 and may at least partially define the hole 76. The outer surface 102 may be disposed opposite the inner surface 100. The outer surface 102 may be an exterior surface of the camshaft tube 74 and may also be radially disposed about the axis 78, but may be located further from the axis 78 than the inner surface 100. The camshaft tube 74 may also have a pair of tube ends 104. The tube ends 104 may have similar configurations and may be mirror images of each other in one or more embodiments. For convenience in reference, the tube end 104 that may be disposed adjacent to the mounting flange 70 may be referred to as the first tube end and the tube end 104 that may be disposed adjacent to the brake wing 72 may be referred to as a second tube end.

The camshaft tube 74 may interconnect the mounting flange 70 and/or the brake wing 72 in various configurations as will be described in more detail below. Moreover, the mounting flange 70 or the brake wing 72 may be integrally formed with the camshaft tube 74 or may have a unitary one-piece configuration with the camshaft tube 74 in one or more embodiments.

Referring to FIG. 1, the camshaft 26 may be configured to actuate the brake pad assemblies 22. The camshaft 26 may extend along and may rotate about the axis 78. The camshaft 26 may extend through the camshaft opening 46 in the spider 20 and the hole 76 in the bracket assembly 24. The camshaft 26 may include a cam disposed at a first end. The cam may be an S-cam and may be configured to engage the cam roller on the brake shoe 60. Rotation of the camshaft 26 may actuate the brake pad assemblies 22 such that the friction material 62 moves toward or engages an inner surface of the brake drum to brake or slow or inhibit rotation of an associated wheel. The camshaft 26 may also include a second end that is disposed opposite the first end. The second end of the camshaft 26 may be disposed proximate and may engage the slack adjuster 28.

The slack adjuster 28 may be provided to compensate for brake wear or wear of the friction material 62. The slack adjuster 28 may be fixedly disposed near the second end of the camshaft 26. For example, the slack adjuster 28 may have a mounting hole that may receive the camshaft 26. The slack adjuster 28 may be coupled to the camshaft 26 in any suitable manner. For instance, the mounting hole of the slack adjuster 28 and the camshaft 26 may have mating splines that may help couple the slack adjuster 28 and a camshaft 26 together.

The actuator 30 may be provided to actuate the camshaft 26. The actuator 30 may be of any suitable type, such as a pneumatic, hydraulic, electrical, or electromechanical actuator. The actuator 30 may include an actuator shaft 110 that may extend toward or to the slack adjuster 28. For example, the actuator shaft 110 may extend through the actuator shaft opening in the brake wing 72. The actuator 30 may move between a retracted position and an extended position. In the retracted position, the camshaft 26 may be positioned such that a brake pad assembly 22 does not engage the brake drum to brake or inhibit rotation of an associated vehicle wheel assembly. In the extended position, the actuator 30 may rotate the camshaft 26 and actuate the brake pad assemblies 22 to move toward and engage the brake drum to inhibit rotation of an associated wheel hub assembly. The actuator 30 may be fixedly mounted to the brake wing 72. For example, the actuator 30 may include one or more mounting features 112, such as a threaded mounting stud that may extend through a mounting hole in the brake wing flange portion 92 and that may receive a washer and nut to fixedly couple the actuator 30 to the brake wing 72.

Referring to FIGS. 3-7, various configurations of brake assembles and connections between the camshaft tube 74 and the mounting flange 70 and/or brake wing 72 will now be described. In each configuration, the camshaft tube 74 may be attached and bonded to the mounting flange 70 and/or the brake wing 72 with an adhesive 120. As such, the bracket assembly 24 may be assembled without welding and without the use of mechanical fasteners. The adhesive 120 may be of any suitable type, such as Dow BETAMATE™ structural adhesive. In addition, it is contemplated that the mounting flange 70 may be integral with the camshaft tube 74 or the brake wing 72 may be integral with the camshaft tube 74 in each of these configurations, thereby providing a two-piece structure with a single adhesive interface between the non-integral components.

Referring to FIGS. 3 and 4, a bracket assembly 24 is shown in which the mounting flange 70 and the brake wing 72 have female configurations and the camshaft tube 74 has a male configuration. The camshaft tube 74 may have a conical surface 130 that may extend from the inner surface 100 to the outer surface 102 of the camshaft tube 74. The conical surface 130 may extend continuously around the axis 78 and may extend at a non-perpendicular angle with respect to the axis 78. A conical surface 130 may be provided with at least one tube end 104 of the camshaft tube 74. In FIGS. 3 and 4, the conical surface 130 is provided at the first and second tube ends.

The mounting flange 70 may have a conical mounting flange surface 132 that may be aligned with the conical surface 130. For example, the conical mounting flange surface 132 may be disposed substantially parallel to the conical surface 130 that is disposed at the first tube end 104 of the camshaft tube 74. As such, the conical surface 130 and the conical mounting flange surface 132 may both be disposed at a non-perpendicular angle with respect to the axis 78. Such angular positioning may help distribute load forces, such as normal load forces that may otherwise weaken or shear the adhesive 120 or chemical bonds between the adhesive 120 and the mounting flange 70 and/or the camshaft tube 74. As such, a more durable bracket assembly 24 may be provided as compared to a design in which the mounting flange 70 and camshaft tube 74 may mate and be adhered solely along flat parallel surfaces that extend substantially perpendicular to the axis 78.

The adhesive 120 may be disposed between the mounting flange 70 and the camshaft tube 74. In addition, the conical surface 130 and the conical mounting flange surface 132 may cooperate to define an adhesive channel 134. The adhesive channel 134 may extend continuously around the axis 78 and may receive the adhesive 120. The adhesive channel 134 may be configured as a groove or indentation that may be provided in the conical surface 130 and the conical mounting flange surface 132. The adhesive channel 134 may be filled with the adhesive 120 and may create a mechanical joint when the adhesive 120 solidifies in addition to the chemical bond provided by the adhesive 120. As such, the adhesive channel 134 may help retain the adhesive 120 and distribute load forces against the mounting flange 70 and camshaft tube 74 in a manner that inhibits shearing of the adhesive 120 or disengagement of the mounting flange 70 from the camshaft tube 74. In one or more embodiments, the adhesive 120 may be locally positioned in the adhesive channel 134 such that the adhesive 120 does not completely separate the mounting flange 70 from the camshaft tube 74. Alternatively, the adhesive 120 may be positioned in the adhesive channel 134 and may extend along regions of the conical surface 130 and the conical mounting flange surface 132 that are disposed adjacent to the adhesive channel 134. As such, the adhesive 120 may engage and bond to the conical surface 130 and the conical mounting flange surface 132 such that the adhesive 120 may be disposed between and may partially or completely separate the conical surface 130 from the conical mounting flange surface 132. It is also contemplated that the adhesive channel 134 may be omitted in one or more embodiments.

The brake wing 72 may have a conical brake wing surface 136 that may be aligned with a conical surface 130. For example, the conical brake wing surface 136 may be disposed substantially parallel to the conical surface 130 that is disposed at the second tube end 104 of the camshaft tube 74. As such, the conical surface 130 and the conical brake wing surface 136 may both be disposed at a non-perpendicular angle with respect to the axis 78. Such angular positioning may help distribute load forces, such as normal load forces that may otherwise shear the adhesive or chemical bonds between the adhesive and the mounting flange 70 and/or the camshaft tube 74 and improve durability as previously discussed.

The adhesive 120 may be disposed between the brake wing 72 and the camshaft tube 74. The conical surface 130 and the conical brake wing surface 136 may cooperate to define an adhesive channel 138. The adhesive channel 138 may continuously extend around the axis 78 and may receive the adhesive 120. The adhesive channel 138 may be configured as a groove or indentation that may be provided in the conical surface 130 and the conical brake wing surface 136. The adhesive channel 138 may be filled with the adhesive 120 and may create a mechanical joint when the adhesive 120 solidifies in addition to the chemical bond provided by the adhesive 120. As such, the adhesive channel 138 may help retain the adhesive 120 and distribute load forces against the brake wing 72 and camshaft tube 74 in a manner that inhibits shearing of the adhesive 120 or disengagement of the brake wing 72 from the camshaft tube 74. In one or more embodiments, the adhesive 120 may be locally positioned in the adhesive channel 138 such that the adhesive 120 does not completely separate the brake wing 72 from the camshaft tube 74. Alternatively, the adhesive 120 may be positioned in the adhesive channel 138 and may extend along regions of the conical surface 130 and the conical brake wing surface 136 that are disposed adjacent to the adhesive channel 138. As such, the adhesive 120 may engage and bond to the conical surface 130 and the conical brake wing surface 136 such that the adhesive 120 may be disposed between and may partially or completely separate the conical surface 130 from the conical brake wing surface 136. It is also contemplated that the adhesive channel 138 may be omitted in one or more embodiments.

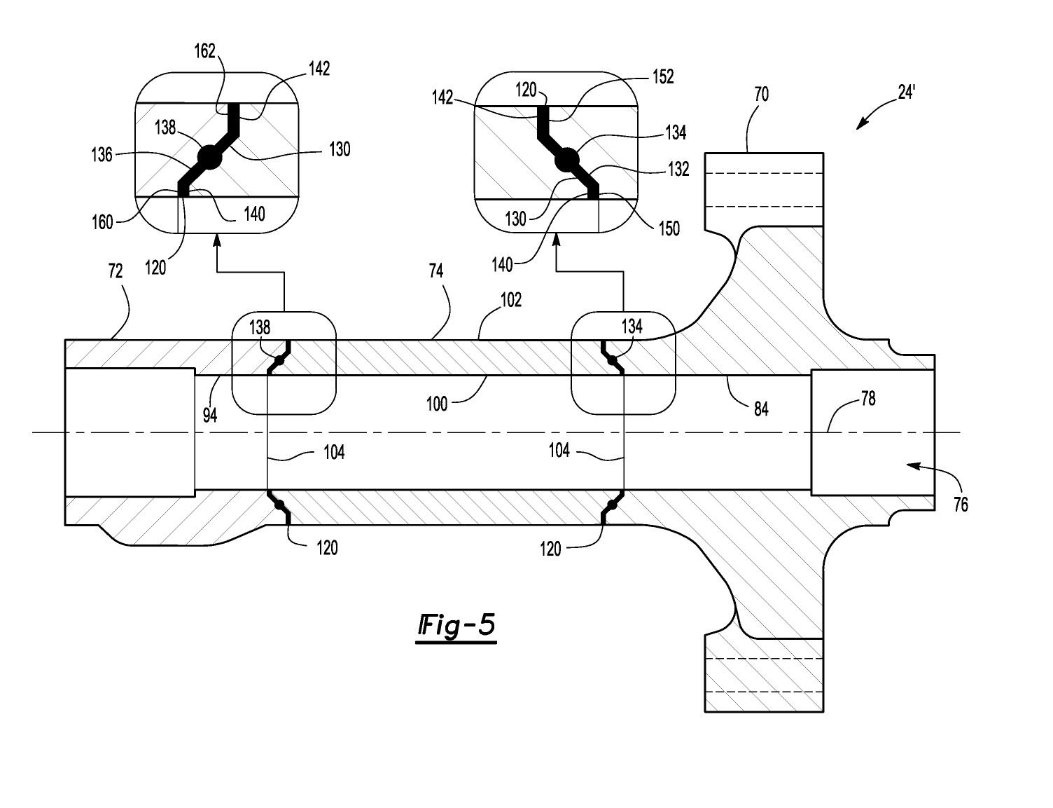

Referring to FIG. 5, a bracket assembly 24′ having another cross section is shown. This embodiment is similar to the embodiment shown in FIG. 4, except that the conical surface 130 of the camshaft tube 74 may not extend from the inner surface 100 to the outer surface 102 of the camshaft tube 74. As such, the camshaft tube 74 may have a conical surface 130 that may be disposed between and may be completely spaced apart from the inner surface 100 and the outer surface 102. The camshaft tube 74 may have a first step surface 140 and a second step surface 142. The first step surface 140 may extend from the inner surface 100 to a first end of the conical surface 130. In addition, the first step surface 140 may be disposed substantially perpendicular to the axis 78. The second step surface 142 may extend from the outer surface 102 to a second end of the conical surface 130 that may be disposed opposite the first end of the conical surface 130. The second step surface 142 may be disposed substantially perpendicular to the axis 78 and may be offset from the first step surface 140 such that the first step surface 140 and the second step surface 142 are not coplanar.

The mounting flange 70 may be configured to mate with the first tube end 104 of the camshaft tube 74. For example, the conical mounting flange surface 132 may be aligned with and may be disposed substantially parallel to the conical surface 130 that is disposed at the first tube end 104. As such, the conical surface 130 and the conical mounting flange surface 132 may both be disposed at a non-perpendicular angle with respect to the axis 78. The mounting flange 70 may also have a first mounting flange step surface 150 and a second mounting flange step surface 152. The first mounting flange step surface 150 may extend from the interior surface 84 to a first end of the conical mounting flange surface 132 and may be disposed substantially perpendicular to the axis 78. The second mounting flange step surface 152 may extend from a second end of the conical mounting flange surface 132 to or toward an outer surface of the mounting flange 70. The second mounting flange step surface 152 may be disposed substantially perpendicular to the axis 78 and may be offset from the first mounting flange step surface 150 such that the first mounting flange step surface 150 and the second mounting flange step surface 152 are not coplanar.

The adhesive 120 may be disposed between the mounting flange 70 and the camshaft tube 74. The conical surface 130 and the conical mounting flange surface 132 may cooperate to define an adhesive channel 134 as previously described. The adhesive 120 may be locally positioned in the adhesive channel 134 such that the adhesive 120 does not completely separate the mounting flange 70 from the camshaft tube 74. Alternatively, the adhesive 120 may be positioned in the adhesive channel 134 and may extend along regions of the conical surface 130 and the conical mounting flange surface 132 that are disposed adjacent to the adhesive channel 134 and/or along the first mounting flange step surface 150 and the second mounting flange step surface 152 and may partially or completely separate the mounting flange 70 from the camshaft tube 74. It is also contemplated that the adhesive channel 134 may be omitted in one or more embodiments.

The brake wing 72 may be configured to mate with the second tube end 104 of the camshaft tube 74. For example, the conical brake wing surface 136 may be aligned with and may be disposed substantially parallel to the conical surface 130 that is disposed at the second tube end 104. As such, the conical surface 130 and the conical brake wing surface 136 may both be disposed at a non-perpendicular angle with respect to the axis 78. The brake wing 72 may also have a first brake wing step surface 160 and a second brake wing step surface 162. The first brake wing step surface 160 may extend from the interior surface 94 to a first end of the conical brake wing surface 136 and may be disposed substantially perpendicular to the axis 78. The second brake wing step surface 162 may extend from a second end of the conical brake wing surface 136 to or toward an outer surface of the brake wing 72. The second brake wing step surface 162 may be disposed substantially perpendicular to the axis 78 and may be offset from the first brake wing step surface 160 such that the first brake wing step surface 160 and the second brake wing step surface 162 are not coplanar.

The adhesive 120 may be disposed between the brake wing 72 and the camshaft tube 74. The conical surface 130 and the conical brake wing surface 136 may cooperate to define an adhesive channel 138 as previously described. The adhesive 120 may be locally positioned in the adhesive channel 138 such that the adhesive 120 does not completely separate the brake wing 72 from the camshaft tube 74. Alternatively, the adhesive 120 may be positioned in the adhesive channel 138 and may extend along regions of the conical surface 130 and the conical brake wing surface 136 that are disposed adjacent to the adhesive channel 138 and/or along the first brake wing step surface 160 and the second brake wing step surface 162 and may partially or completely separate the brake wing 72 from the camshaft tube 74. It is also contemplated that the adhesive channel 138 may be omitted in one or more embodiments.

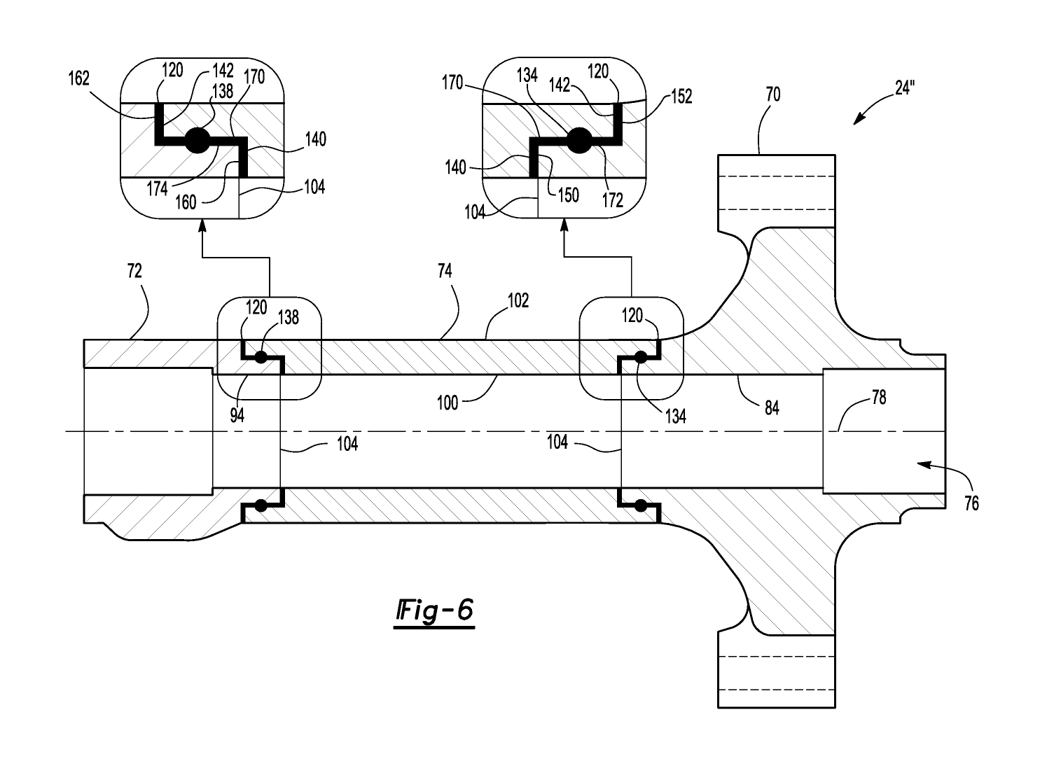

Referring to FIG. 6, a bracket assembly 24″ that lacks conical surfaces is shown. The camshaft tube 74 may have a first step surface 140, a second step surface 142, and a connecting surface 170. The first step surface 140 may extend from the inner surface 100 to a first end of the connecting surface 170 and may be disposed substantially perpendicular to the axis 78. The second step surface 142 may extend from the outer surface 102 to a second end of the connecting surface 170 that may be disposed opposite the first end of the connecting surface 170. The second step surface 142 may be disposed substantially perpendicular to the axis 78 and may be offset from the first step surface 140 as previously discussed. The connecting surface 170 may be disposed substantially parallel to the axis 78 in one or more embodiments.

The mounting flange 70 may be configured to mate with the first tube end 104 of the camshaft tube 74. The mounting flange 70 may have a first mounting flange step surface 150, a second mounting flange step surface 152, and a mounting flange connecting surface 172. The first mounting flange step surface 150 may extend from the interior surface 84 to a first end of the mounting flange connecting surface 172 and may be disposed substantially perpendicular to the axis 78. The second mounting flange step surface 152 may extend from a second end of the mounting flange connecting surface 172 to or toward an outer surface of the mounting flange 70. The second mounting flange step surface 152 may be disposed substantially perpendicular to the axis 78 and may be offset from the first mounting flange step surface 150 as previously discussed. The mounting flange connecting surface 172 may be disposed substantially parallel to the axis 78 in one or more embodiments. In addition, the mounting flange connecting surface 172 may be disposed substantially parallel to the connecting surface 170.

The adhesive 120 may be disposed between the mounting flange 70 and the camshaft tube 74. The connecting surface 170 and the mounting flange connecting surface 172 may cooperate to define an adhesive channel 134 as previously described. The adhesive 120 may be locally positioned in the adhesive channel 134 such that the adhesive 120 does not completely separate the mounting flange 70 from the camshaft tube 74. Alternatively, the adhesive 120 may be positioned in the adhesive channel 134 and may extend along regions of the connecting surface 170 and the mounting flange connecting surface 172 that are disposed adjacent to the adhesive channel 134 and/or along the first mounting flange step surface 150 and the second mounting flange step surface 152 and may completely separate the mounting flange 70 from the camshaft tube 74. It is also contemplated that the adhesive channel 134 may be omitted in one or more embodiments.

The brake wing 72 may be configured to mate with the second tube end 104 of the camshaft tube 74. The brake wing 72 may have a first brake wing step surface 160, a second brake wing step surface 162, and a brake wing connecting surface 174. The first brake wing step surface 160 may extend from the interior surface 94 to a first end of the brake wing connecting surface 174 and may be disposed substantially perpendicular to the axis 78. The second brake wing step surface 162 may extend from a second end of the brake wing connecting surface 174 to or toward an outer surface of the brake wing 72. The second brake wing step surface 162 may be disposed substantially perpendicular to the axis 78 and may be offset from the first brake wing step surface 160 as previously discussed. The brake wing connecting surface 174 may be disposed substantially parallel to the axis 78 in one or more embodiments. In addition, the brake wing connecting surface 174 may be disposed substantially parallel to the connecting surface 170.

The adhesive 120 may be disposed between the brake wing 72 and the camshaft tube 74. The connecting surface 170 and the brake wing connecting surface 174 may cooperate to define an adhesive channel 138 as previously described. The adhesive 120 may be locally positioned in the adhesive channel 138 such that the adhesive 120 does not completely separate the brake wing 72 from the camshaft tube 74. Alternatively, the adhesive 120 may be positioned in the adhesive channel 138 and may extend along regions of the connecting surface 170 and the brake wing connecting surface 174 that are disposed adjacent to the adhesive channel 138 and/or along the first brake wing step surface 160 and the second brake wing step surface 162 and may completely separate the brake wing 72 from the camshaft tube 74. It is also contemplated that the adhesive channel 138 may be omitted in one or more embodiments.

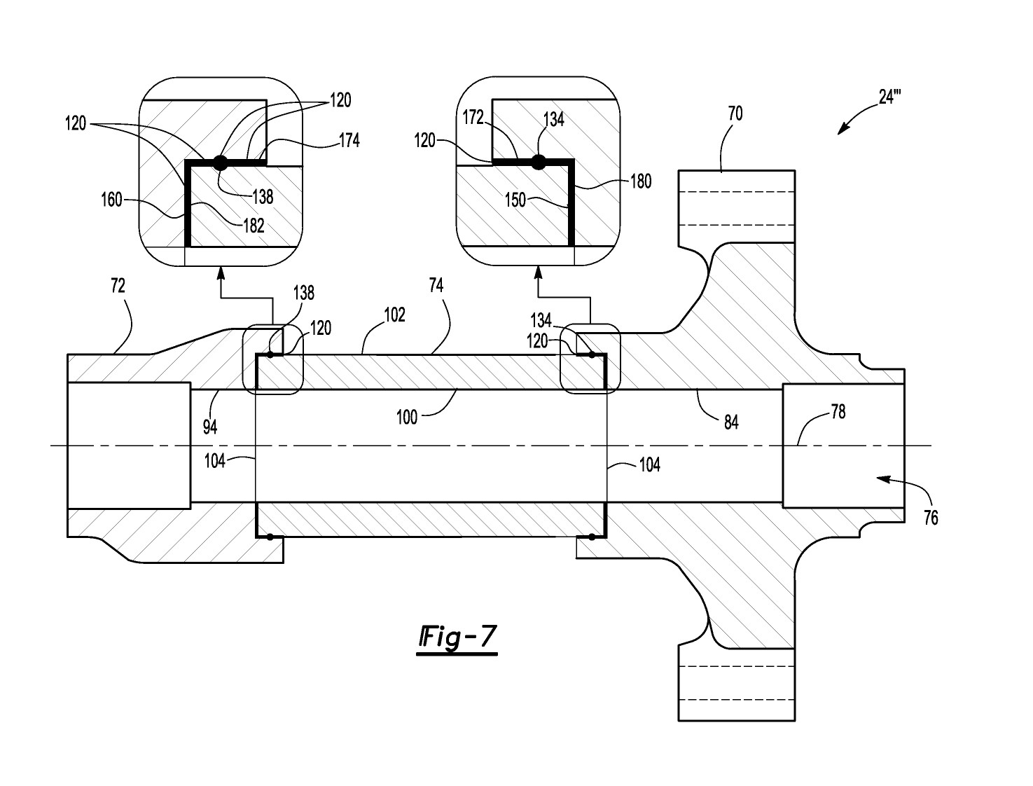

Referring to FIG. 7, another bracket assembly 24′″ that lacks conical surfaces is shown. The camshaft tube 74 may have an inner surface 100, an outer surface 102, a first tube end surface 180, and a second tube end surface 182. The first tube end surface 180 may extend from the inner surface 100 to the outer surface 102 and may face toward the mounting flange 70. The second tube end surface 182 may be disposed opposite the first tube end surface 180. In addition, the second tube end surface 182 may also extend from the inner surface 100 to the outer surface 102 and may face toward the brake wing 72. The first tube end surface 180 and/or the second tube end surface 182 may be disposed substantially perpendicular to the axis 78 in one or more embodiments.

The mounting flange 70 may be configured to mate with the first tube end 104 of the camshaft tube 74. The mounting flange 70 may have a first mounting flange step surface 150 and a mounting flange connecting surface 172. The first mounting flange step surface 150 may extend from the interior surface 84 to a first end of the mounting flange connecting surface 172 and may be disposed substantially perpendicular to the axis 78. The mounting flange connecting surface 172 may be disposed substantially parallel to the axis 78 and the outer surface 102. As such, the mounting flange connecting surface 172 may extend continuously around the outer surface 102 and may be configured as a socket that may receive the first tube end 104 of the camshaft tube 74. As such, the mounting flange connecting surface 172 may be disposed outward from the outer surface 102 or further from the axis 78 than the outer surface 102 in one or more embodiments.

The adhesive 120 may be disposed between the outer surface 102 and the mounting flange connecting surface 172. In addition, the outer surface 102 and the mounting flange connecting surface 172 may cooperate to define an adhesive channel 134. The adhesive 120 may be locally positioned in the adhesive channel 134 such that the adhesive 120 does not completely separate the mounting flange 70 from the camshaft tube 74. Alternatively, the adhesive 120 may be positioned in the adhesive channel 134 and may extend along regions of the outer surface 102 and the mounting flange connecting surface 172 that are disposed adjacent to the adhesive channel 134 and/or between the first mounting flange step surface 150 and the first tube end surface 180. As such, the adhesive 120 may partially or completely separate the mounting flange 70 from the camshaft tube 74. It is also contemplated that the adhesive channel 134 may be omitted in one or more embodiments.

The brake wing 72 may be configured to mate with the second tube end 104 of the camshaft tube 74. The brake wing 72 may have a first brake wing step surface 160 and a brake wing connecting surface 174. The first brake wing step surface 160 may extend from the interior surface 94 to a first end of the brake wing connecting surface 174 and may be disposed substantially perpendicular to the axis 78. The brake wing connecting surface 174 may be disposed substantially parallel to the axis 78 and the outer surface 102. As such, the brake wing connecting surface 174 may extend continuously around the outer surface 102 and may be configured as a socket that may receive the second tube end 104 of the camshaft tube 74. As such, the brake wing connecting surface 174 may be disposed outward from the outer surface 102 or further from the axis 78 than the outer surface 102 in one or more embodiments.

The adhesive 120 may be disposed between the outer surface 102 and the brake wing connecting surface 174. In addition, the outer surface 102 and the brake wing connecting surface 174 may cooperate to define an adhesive channel 138. The adhesive 120 may be locally positioned in the adhesive channel 138 such that the adhesive 120 does not completely separate the brake wing 72 from the camshaft tube 74. Alternatively, the adhesive 120 may be positioned in the adhesive channel 138 and may extend along regions of the outer surface 102 and the brake wing connecting surface 174 that are disposed adjacent to the adhesive channel 138 and/or between the first brake wing step surface 160 and the second tube end surface 182. As such, the adhesive 120 may partially or completely separate the brake wing 72 from the camshaft tube 74. It is also contemplated that the adhesive channel 138 may be omitted in one or more embodiments.

The bracket assembly may be manufactured in the following manner. First, the components of the bracket assembly may be provided and the mating surfaces may be machined as needed to provide compatible mating surfaces. The bracket assembly components, such as the mounting flange, the brake wing, and the camshaft tube may be made of an aluminum alloy using any suitable technique, such as casting, extruding, or forging. Providing components made of an aluminum alloy may provide significant weight savings as compared to other materials like steel, thereby helping reduce vehicle weight and improve vehicle fuel economy. Unfortunately, components made from aluminum alloys may be difficult to weld together and the heat that is applied during welding may reduce the strength of the aluminum alloy proximate the weld, thereby reducing the strength and durability of the assembly. Next, the adhesive may be applied to at least one part, such as by spraying or applying a bead of adhesive to at least one mating surface. The use of an adhesive may eliminate welding and the associated reduction in strength caused by high welding temperatures. The parts may then be aligned and assembled such that the adhesive may bond the individual parts together and form the brake assembly. In addition, the parts may be held together under pressure and the adhesive may be allowed to cure or harden to join the individual parts. The bracket assembly may then undergo subsequent manufacturing and assembly steps with other components to help create the brake assembly.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A brake assembly comprising:
a bracket assembly that receives a camshaft for actuating a brake pad assembly, the bracket assembly including:
a camshaft tube that extends along an axis and that has a first tube end and a second tube end disposed opposite the first tube end; and
a mounting flange disposed proximate the first tube end, wherein the mounting flange is attached to the camshaft tube with an adhesive that is disposed between the mounting flange and the camshaft tube;
wherein the mounting flange and the camshaft tube cooperate to define a hole that receives the camshaft.

2. The brake assembly of claim 1 wherein the camshaft tube has a conical surface that extends at non-perpendicular angle with respect to the axis and the mounting flange has a conical mounting flange surface that is disposed substantially parallel to the conical surface, wherein the adhesive is disposed between the conical surface and the conical mounting flange surface.

3. The brake assembly of claim 2 wherein the conical surface and the conical mounting flange surface cooperate to define an adhesive channel that extends around the axis and that receives the adhesive.

4. The brake assembly of claim 2 wherein the camshaft tube has an inner surface and an outer surface that is disposed opposite the inner surface, wherein the conical surface extends from the inner surface to the outer surface.

5. The brake assembly of claim 2 wherein the camshaft tube has an inner surface and an outer surface that is disposed opposite the inner surface, wherein the conical surface is disposed between and is spaced apart from the inner surface and the outer surface.

6. The brake assembly of claim 5 wherein the camshaft tube further comprises a first step surface that extends from the inner surface to a first end of the conical surface and a second step surface that extends from the outer surface to a second end of the conical surface that is disposed opposite the first end of the conical surface, wherein the first step surface and the second step surface are disposed substantially perpendicular to the axis.

7. The brake assembly of claim 1 wherein the camshaft tube has an inner surface, an outer surface that is disposed opposite the inner surface, a first step surface that extends from the inner surface toward the outer surface, a second step surface that extends from the outer surface toward the inner surface, and a connecting surface that extends from the first step surface to the second step surface, and the mounting flange has a mounting flange connecting surface that is disposed substantially parallel to the connecting surface, wherein the adhesive is disposed between the connecting surface and the mounting flange connecting surface.

8. The brake assembly of claim 7 wherein the connecting surface and the mounting flange connecting surface cooperate to define an adhesive channel that extends around the axis and that receives the adhesive.

9. The brake assembly of claim 1 wherein the camshaft tube has an inner surface and an outer surface that is disposed opposite the inner surface and the mounting flange has a mounting flange connecting surface that is disposed substantially parallel to the outer surface, wherein the adhesive is disposed between the outer surface and the mounting flange connecting surface.

10. The brake assembly of claim 9 wherein the outer surface and the mounting flange connecting surface cooperate to define an adhesive channel that extends around the axis and that receives the adhesive.

11. A brake assembly comprising:
a bracket assembly that receives a camshaft for actuating a brake pad assembly, the bracket assembly including:
a camshaft tube that extends along an axis and that has a first tube end and a second tube end disposed opposite the first tube end; and
a brake wing that disposed proximate the second tube end and that is adapted to support an actuator for actuating the camshaft, wherein the brake wing is attached to the camshaft tube with an adhesive that is disposed between the brake wing and the camshaft tube;
wherein the brake wing and the camshaft tube cooperate to define a hole that receives the camshaft.

12. The brake assembly of claim 11 wherein the camshaft tube has a conical surface that extends at non-perpendicular angle with respect to the axis and the brake wing has a conical brake wing surface that is disposed substantially parallel to the conical surface, wherein the adhesive is disposed between the conical surface and the conical brake wing surface.

13. The brake assembly of claim 12 wherein the conical surface and the conical brake wing surface cooperate to define an adhesive channel that extends around the axis and that receives the adhesive.

14. The brake assembly of claim 12 wherein the camshaft tube has an inner surface and an outer surface that is disposed opposite the inner surface, wherein the conical surface extends from the inner surface to the outer surface.

15. The brake assembly of claim 12 wherein the camshaft tube has an inner surface and an outer surface that is disposed opposite the inner surface, wherein the conical surface is disposed between and is spaced apart from the inner surface and the outer surface.

16. The brake assembly of claim 15 wherein the camshaft tube further comprises a first step surface that extends from the inner surface to a first end of the conical surface and a second step surface that extends from the outer surface to a second end of the conical surface that is disposed opposite the first end of the conical surface, wherein the first step surface and the second step surface are disposed substantially perpendicular to the axis.

17. The brake assembly of claim 11 wherein the camshaft tube has an inner surface, an outer surface that is disposed opposite the inner surface, a first step surface that extends from the inner surface toward the outer surface, a second step surface that extends from the outer surface toward the inner surface, and a connecting surface that extends from the first step surface to the second step surface, and the brake wing has a brake wing connecting surface that is disposed substantially parallel to the connecting surface, wherein the adhesive is disposed between the connecting surface and the brake wing connecting surface.

18. The brake assembly of claim 17 wherein the connecting surface and the brake wing connecting surface cooperate to define an adhesive channel that extends around the axis and that receives the adhesive.

19. The brake assembly of claim 11 wherein the camshaft tube has an inner surface and an outer surface that is disposed opposite the inner surface and the brake wing has a brake wing connecting surface that is disposed substantially parallel to the outer surface, wherein the adhesive is disposed between the outer surface and the brake wing connecting surface.

20. The brake assembly of claim 19 wherein the outer surface and the brake wing connecting surface cooperate to define an adhesive channel that extends around the axis and that receives the adhesive.
